(19) United States
(12) Patent Application Publication
(10) Pub. No.: US 2026/0315919 A1
(43) Pub. Date: Oct. 15, 2026

(54) MULTI-MODAL COMPUTER GAME FEEDBACK USING CONVERSATIONAL DIGITAL ASSISTANT

(71) Applicant: Sony Interactive Entertainment Inc., Tokyo (JP)

(72) Inventors: Michael TAYLOR, San Mateo, CA (US); Celeste BEAN, San Mateo, CA (US)

(21) Appl. No.: 19/722,296

(22) Filed: Jun. 26, 2026

Related U.S. Application Data
(63) Continuation of application No. 18/361,589, filed on Jul. 28, 2023, now abandoned.

(51) Int. Cl. A63F 13/424; A63F 13/215; A63F 13/285; A63F 13/533; A63F 13/54; G06N 3/0475

(52) U.S. Cl. CPC A63F 13/424; A63F 13/215; A63F 13/285; A63F 13/533; A63F 13/54; G06N 3/0475

(57) ABSTRACT

An electronic system is configured to use a tailored large language model to process natural language spoken by a computer gamer during gameplay. Non-verbal output can then be provided in response, where the non-verbal output may be visual, tactile, and/or audible. As examples, the non-verbal output may respond to a request from the user, may acknowledge that the natural language is being processed, and/or may indicate that a requested action has been registered for execution in the future.

### CROSS-REFERENCE TO RELATED APPLICATIONS

The present application is a continuation of U.S. Application No. 18/361,589, filed Jul. 28, 2023 and titled “MULTI-MODAL COMPUTER GAME FEEDBACK USING CONVERSATIONAL DIGITAL ASSISTANT,” the content of which is incorporated herein by reference in its entirety for all purposes.

### FIELD

The disclosure below relates generally to multi-model computer game feedback using a conversational digital assistant.

### BACKGROUND

As recognized herein, one of the technical challenges facing computer game developers and console makers alike is the need to provide more robust forms of output to enrich the gaming experience and enhance execution of the game itself. As further recognized herein, additional gains can be made in this area.

### SUMMARY

Accordingly, in one aspect, an apparatus includes at least one processor assembly programmed with instructions to execute a computer game and to receive verbal input from a user. The verbal input is related to the computer game. The at least one processor assembly is also programmed with instructions to execute a large language model to process the verbal input and to, based on the processing of the verbal input, determine a non-verbal response related to the computer game. The non-verbal response indicates that the verbal input is being processed and is a response other than execution of a command within the computer game. The at least one processor assembly is also programmed with instructions to output the non-verbal response based on the determination.

In various example implementations, the non-verbal response may include a non-verbal acknowledgement that the verbal input has been received.

Also in various example implementations, the non-verbal response may include a non-verbal visual response. The non-verbal visual response may include presenting a screen border in a particular color, illuminating a button on a computer game controller, and/or illuminating a light on a peripheral device different from the computer game controller. The non-verbal response may additionally or alternatively include a non-verbal tactile response. The non-verbal tactile response may include vibrating, to indicate a direction indicated in the verbal input, a computer game controller in the direction and/or at a particular location corresponding to the direction. Still further, the non-verbal response may include a non-verbal audible response. The non-verbal audible response may include a first predetermined sound corresponding to “yes” and a second predetermined sound corresponding to “no”.

Additionally, if desired the non-verbal response may be a first output, the verbal input may include a request to be alerted when a predetermined game action occurs, and the non-verbal response may include an acknowledgement of the request. Here, the at least one processor assembly may be programmed with instructions to identify the game action as occurring subsequent to outputting the non-verbal response and, based on identification of the game action as occurring, rendering a second output different from the first output. The second output may establish an alert in conformance with the request.

In another aspect, a method includes executing a computer game and receiving verbal input from a user. The verbal input is related to the computer game. The method also includes executing a model to process the verbal input and, based on the processing of the verbal input, determining a non-verbal response related to the computer game. The non-verbal response is a response other than execution of a command within the computer game. The method also includes outputting the non-verbal response based on the determination.

In various examples, the model may include a large language model.

Also in various examples, the non-verbal response may indicate that a user request has been registered for execution in the future. Additionally or alternatively, the non-verbal response may be a binary response. As another example, the non-verbal response may include actuating a first button on a computer game controller for “yes” and actuating a second button on the computer game controller for “no”, where actuating the first and second buttons may include vibrating the respective button relative to other portions of the computer game controller and/or illuminating the respective button.

If desired, in some example implementations the model may be executed outside of a game engine used to execute the computer game.

Also in some example implementations, the method may include determining the non-verbal response based on the processing of the verbal input and based on a game context associated with the computer game.

In still another aspect, a system includes at least one computer medium that is not a transitory signal. The at least one computer medium includes instructions executable by at least one processor assembly to execute a computer game and to receive verbal input from a user. The verbal input is related to the computer game. The instructions are also executable to execute a model to process the verbal input and, based on the processing of the verbal input, determine a non-verbal response. The non-verbal response is a response other than execution of a command within the computer game. The instructions are also executable to output the non-verbal response based on the determination.

Thus, in various examples the verbal input may include a user exclamation that does not include a computer game command, and the non-verbal response may include a suggestion to re-map buttons on a computer game controller from a first configuration to a second configuration.

As another example, the verbal input may include a user question asking which input element on a computer game controller is usable to provide a particular game command, and the non-verbal response may include one or more of illumination of the input element usable to provide the particular game command and/or vibration of the input element usable to provide the particular game command.

If desired, the model may include a large language model.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows an example graphical user interface (GUI) that may be presented on a display prior to gameplay for a user to choose whether to use a conversational digital assistant while playing a computer game consistent with present principles;

FIGS. 3 and 4 are illustrations of two example scenarios where a user provides a verbal, natural language-based input and the assistant provides various non-verbal outputs in response;

FIG. 5 is an example flow chart of example overall logic executable by one or more devices consistent with present principles;

FIG. 6 shows example training logic that may be executed to train a machine learning (ML) model/large language model to infer various non-verbal outputs based on verbal inputs consistent with present principles;

FIG. 7 shows example artificial intelligence/software architecture for a conversational digital assistant consistent with present principles; and

FIG. 8 shows an example settings GUI that may be used to configure one or more settings of the assistant/system to operate consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation^{®} or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation^{®}, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implements methods of providing a secure community such as an online social website or gamer network to network members.

A processor may be a single- or multi-chip processor that can execute logic by means of various lines such as address lines, data lines, and control lines and registers and shift registers. A processor assembly may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

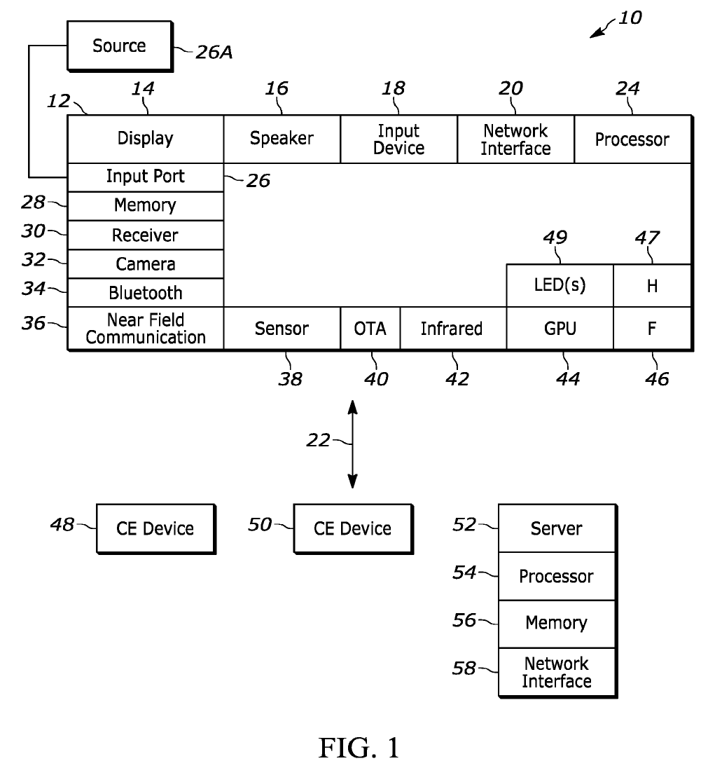

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled 5G (“smart”) telephone, a tablet computer, a notebook computer, a head-mounted device (HMD) such as smart glasses or other wearable computerized device (e.g., AR or VR headset), a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a, when implemented as a game console, may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor’s rotatable shaft so that the shaft may rotate under control of the motor (which in turn may be controlled by a processor such as the processor 24) to create vibration of various frequencies and/or amplitudes as well as force simulations in various directions.

As also shown in FIG. 1, the AVD 12 may include one or more light-emitting diodes (LEDs) 49 and/or other types of lights. The LEDs/lights 49 may be controllable to output light in green, red, blue, yellow, purple, and other colors, for example. Also note that the LEDs/lights 49 may be separate from and not embodied in the display/monitor 14 in certain non-limiting examples.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

The components shown in the following figures may include some or all components shown in FIG. 1. The user interfaces (UI) described herein may be consolidated, expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

Now suppose a computer gamer/end-user is about to begin playing a computer game. Also assume that a conversational digital assistant, embodying an artificial intelligence-based model, is loaded onto and executable by one or more devices such as the gamer’s local video game console and/or a remotely located host server. The model itself may be or include a large language model (LLM), such as a generative pretrained transformer neural network or other type of LLM. The LLM may be trained through deep learning to process audio-based input of users speaking conversationally in natural language while the users play computer games, and to then provide a generative response based on that. Rules-based algorithms may also be incorporated into the assistant as appropriate to help the assistant generate the response. And the determined response itself may be a non-verbal response to the user’s verbal input, where the non-verbal response may not be a direct command to immediately control a computer game character in response or to immediately control the game/virtual environment in response. Instead, the non-verbal response may take the form of a non-verbal acknowledgement of the user speaking, assistance in playing the game itself, the registering of a user command to execute in the game in the future, other feedback, etc.

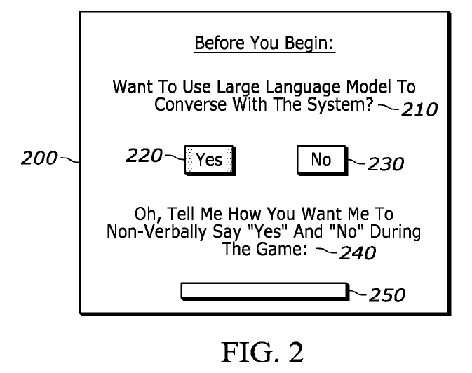

With the foregoing in mind, FIG. 2 shows an example graphical user interface (GUI) 200 that may be presented on a display controlled by the console/server. The GUI 200 may include a prompt 210 asking the end-user whether the user would like to use the digital assistant to converse with the gaming system itself. A “yes” selector 220 is presented and selectable for the user to respond in the affirmative, while a “no” selector 230 is also presented and selectable for the user to respond in the negative. In the present example, the yes selector 220 has been selected, as indicated by the shading shown on the selector 220.

Responsive to the selector 220 being selected, the GUI 200 may dynamically update to also present another prompt 240 asking the user how the user would like the conversational digital assistant to non-verbally respond “yes” and “no” to audible natural language provided by the user. The user may then audibly speak in natural language, indicating how the user would like the assistant to respond to binary yes/no questions by verbally indicating a desired non-verbal “yes” response to be output by the assistant and a desired non-verbal “no” response to be output by the assistant. For example, the user might say “blink my IoT lights once for ‘yes’ and twice for ‘no.’” This speech may be detected by a local microphone that provides its input to the assistant for the assistant to then process the input using the LLM and set itself to respond to future user questions and other natural language in conformance with the user’s audible instructions.

Note that the audible instructions themselves may also be converted to text using a speech-to-text algorithm. The resulting text may then be presented in input box 250 for the user to appreciate that the audible input was correctly received and processed. But also note that, if desired, the user may direct text-based input to the input box 250 using a hard or soft keyboard to similarly provide natural language setting forth desired non-verbal responses to which the assistant is to conform.

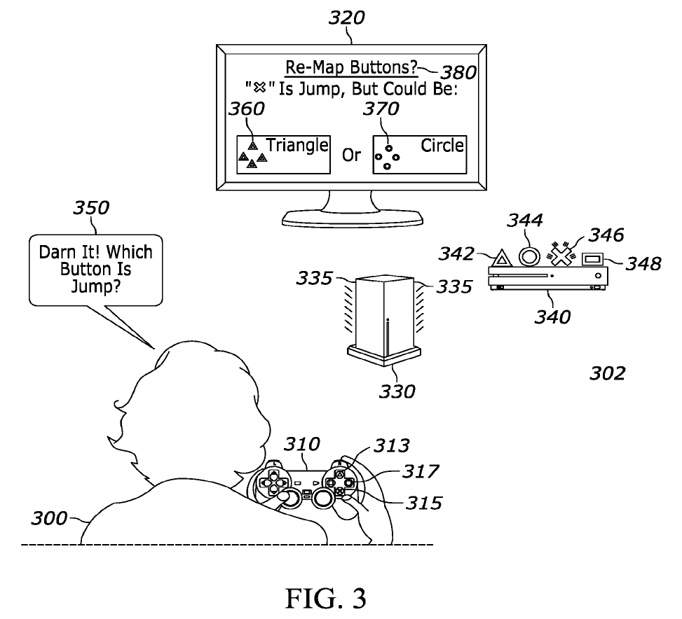

Continuing with this example, reference is now made to the illustration of FIG. 3. As shown, a gamer/end-user 300 has a computer game controller 310 in hand. Note that the controller 310 has been enlarged in FIG. 3 for illustration.

As also shown in FIG. 3, a television 320 is being used to present visual computer game content for the computer game that the user is playing. And as mentioned above, the computer game and the conversational digital assistant itself may be executed using a host server and/or a local game console 330 (e.g., Sony’s PlayStation 5) that controls the display 320. Speakers on the television 320 may also be used to present the associated audible game content from the computer game. Further note that the server/console 330 may also control the controller 310 through wireless communication to provide commands to the controller 310 and to receive user input therefrom. Additionally, the server/console 330 may wirelessly control one or more additional peripheral devices besides the controller 310 itself, such as a peripheral device 340.

Describing the peripheral device 340 in more detail, it may be an electronic three-dimensional (3D) sign configured for non-verbally acknowledging and responding to conversational natural language of the user 300. The device 340 may therefore include plural independently-controllable 3D lights 342, 344, 346, and 348 (e.g., LEDs) arranged in different 3D shapes that correspond to different respective buttons on the controller 310 itself. Each light 342-348 may therefore independently illuminate in the color green, red, blue, and purple, respectively. Respective controller buttons on the controller 310 may also exhibit the same shape and color as a respective light 342-348. For instance, a given controller button may include a respective graphic on top of it, with the respective graphic being in the same color and shape as the corresponding light 342-348. Also note for completeness that each respective controller button may be pressed to provide a different input command to the computer game that is being executed.

Now suppose per FIG. 3 that the user 300 audibly exclaims, as illustrated by speech bubble 350, a term of frustration along with a question “Which button is jump?” as asked more to the user themselves than to the conversational digital assistant that is nonetheless monitoring the user’s audible speech. In response to processing this audible input, the assistant may then take any number of non-verbal multi-modal actions acknowledging this verbal input. For instance, the assistant may illuminate LEDs 335 extending vertically on the console 330 in a blue color (as indicated by the illumination lines shown) to non-verbally respond that the jump button is the “X” button 315 on the controller 310, as also colored blue.

The “X” button 315 itself may also be illuminated with blue light (e.g., while the lights for other buttons and other input elements on the controller 310 are not illuminated at all) to draw the user’s attention to the particular button addressing the user’s natural language, in that selection of the button 315 results in a jump action of the user’s game character within the game. Additionally or alternatively, the button 315 may vibrate relative to other aspects of the controller. For example, a vibrator inside the controller 310 or even coupled directly to the button 315 itself may drive tactile vibration to the button 315 but not to other input elements on the controller 310. Accordingly, further note here that the buttons as well as other input elements on the controller 315 may each include a respective independently-controllable LED and vibrator underneath or forming part of the respective input element itself to thus illuminate and/or vibrate the respective input element as described herein.

As an additional example non-verbal response, the assistant may also illuminate the “X” light 346 on the peripheral device 340 with blue lighting (e.g., while the other lights 342, 344, and 348 are not turned on at all). This may be done to further draw the user’s attention to the particular button addressing the user’s natural language, since the “X” symbol and blue light color from the light 346 correspond to the “X” symbol and blue light color on the button 315.

As yet another example non-verbal response, the assistant may present non-verbal graphics 360, 370 on the display 320. Note that in such a circumstance, the computer game itself may be paused in response to the user’s exclamation and/or the presentation of the graphics 360, 370. Or in other examples, the graphics 360, 370 may be presented inset in picture-in-picture format while the visual game content continues to be presented and the game itself continues to be played.

In any case, the graphics 360, 370 may indicate alternative button mapping configurations that may be implemented by the system for the user to control the computer game. Graphic 360 indicates that another button (the triangle button 313) may be re-mapped so that input to the triangle button 313 on the controller 310 is translated into a jump command rather than input to the “X” button 315. The graphic 370 indicates that yet another button (the circle button 317) may be re-mapped so that input to the circle button 317 on the controller 310 is translated into a jump command rather than input to the “X” button 315. Each graphic 360, 370 may be selectable via voice command, cursor input, or other input means.

For completeness, also note that verbal responses may also be provided by the assistant in certain circumstances. As such, the graphics 360, 370 may be accompanied by a text-based prompt 380 asking the user whether the user would like the controller buttons re-mapped from a first configuration to a second configuration so that different buttons correspond to different game commands than the current one-to-one button-to-command mapping that is operative. As also shown in FIG. 3, the prompt 380 may include additional text indicating the current mapping of the “X” button 315 to a jump command, along with an instruction to choose from other potential mappings (as represented by the graphics 360, 370 themselves and the respective names for the respective buttons as also shown with the respective graphics 360, 370).

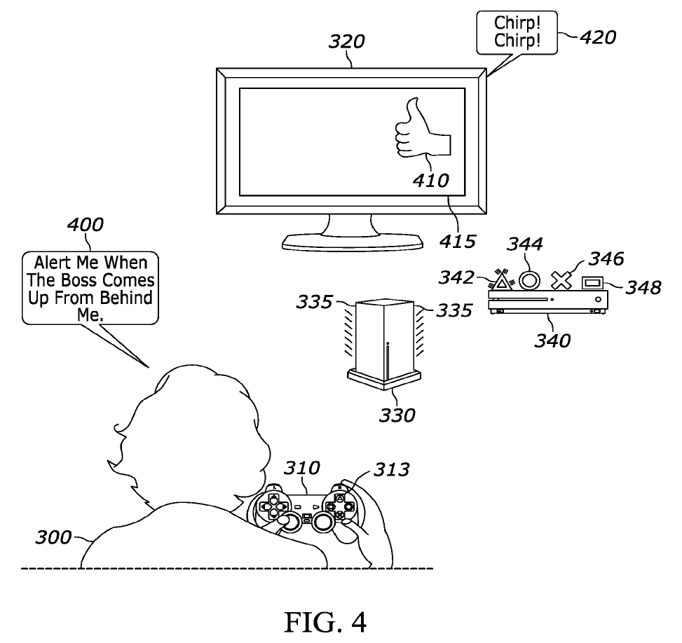

Turning now to FIG. 4, another example is shown consistent with present principles. Here, the same user 300 is still playing the same computer game using the same setup as in FIG. 3. But as shown in FIG. 4, the user 300 audibly instructs the assistant/system, as illustrated by speech bubble 400, to alert the user 300 when a non-user virtual boss (adversary) from the computer game approaches the user’s own virtual character within the virtual world of the computer game. In response to processing this audible input, here too the assistant may take any number of multi-modal, non-verbal actions.

For instance, the assistant may illuminate the LEDs 335 in a green color (as indicated by the illumination lines shown), non-verbally responding with green color to confirm that the user’s verbal command has been received and registered for the assistant/system to then autonomously take the requested action in the future based on the user-indicated game action occurring at an indeterminate time in the future. The triangle button 313 itself may also be illuminated in green (e.g., while the lights for other buttons and other input elements on the controller 310 are not illuminated at all) to provide a similar indication acknowledging/confirming the processing and registering of the command for the future. The button 313 might also vibrate, or the whole controller 310 itself may vibrate, as an additional non-verbal response. As still another example, the assistant may also illuminate the triangle light 342 on the peripheral device 340 with green lighting (e.g., while the other lights 344, 346, and 348 are not powered on at all) to provide yet another indication acknowledging/confirming the processing and registering of the command for the future.

As still other example non-verbal responses, the assistant may present a non-verbal graphic 410 on the display 320 and may also present a screen border 415 in a particular color. Here, the graphic 410 is a thumbs-up icon, providing yet another indication acknowledging that the user’s audible command has been processed and registered for a future game action.

The border 415 may be a border of a predetermined thickness along all peripheries of the front face of the display 320. The border 415 may be dynamically presented in response to the non-verbal user input itself. Therefore, the border 415 may be presented in a particular color depending on the inferred response. For example, the border 415 may be presented in green to provide acknowledgment that the user’s audible command has been processed and registered, while the border 415 may also be presented in red should some sort of negative non-verbal response be inferred for output instead (e.g. responding “no” to the user or indicating that the requested action is not possible).

If desired, an audible non-verbal response may also be provided using speakers on the display 320 and/or as located elsewhere within the user’s local environment. Here the non-verbal response is illustrated by speech bubble 420, which shows audible but non-verbal chirping sounds that would be heard by the user as acknowledgement/confirmation that the command was processed and registered. In certain particular examples, this non-verbal chirping response may be a sound effect sourced from the computer game itself so that the user may remain immersed in the game while still receiving acknowledgement from the system. But further note that should a negative non-verbal response be inferred as appropriate instead, the assistant might output audio using another sound effect sourced from the computer game, such as the sound of a vulture screeching.

Also note per the example of FIG. 4 that the game may not be paused in response to receipt/processing of the user’s audible natural language command. Instead, the game may continue to be played out by the game engine while registering the action in the background, creating a seamless conversational experience for the user while the user plays the computer game uninterrupted.

Furthermore, additionally note per this example that when the condition conforming to the user’s audible command is ultimately satisfied – here the boss character coming up behind the user’s character – the system/assistant itself may provide verbal and/or non-verbal alerts to serve as notifications. For example, a visual “Alert – Boss!” warning may be presented on the display 320. Audible warnings in the form of emergency alert tones or even a computer-generate voice may also be provided to indicate the boss is coming up behind the user’s game character. Tactile responses may also be presented at the controller 310, such as intense, discrete vibrations over time as presented at high frequency intervals.

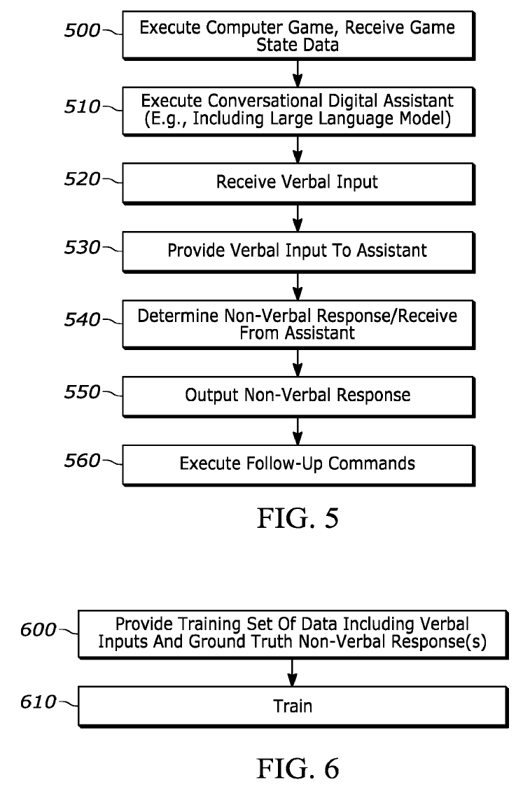

Referring now to FIG. 5, it shows example logic that may be executed by one or more devices consistent with present principles. For example, steps in the logic of FIG. 5 may be executed alone or in any appropriate combination by a personal computer, a gaming console, and/or an Internet-based cloud gaming server. Additionally, in certain specific non-limiting examples, the steps in the logic of FIG. 5 may be executed by a conversational digital assistant application (“app”) and/or the game engine of the particular computer game that is being played. Further note that while the logic of FIG. 5 is shown in flow chart format, other suitable logic may also be used.

Beginning at block 500, the device may execute the computer game itself. This might include, for instance, using the game engine to load an instance of the computer game and then presenting the computer game in accordance with user commands. Then, also at block 500 and while the game is executing, game state data indicating the current state of the computer game may be received. The game state data may include various contexts and other particularized data for the respective game instance itself that is being executed, such as current player health level, current player currency acquired, current weapons arsenal for the player, current level of the computer game itself, current location of the player’s character within the game world, other active users currently playing the same game instance with the player themselves, etc.

From block 500 the logic may then proceed to block 510. At block 510, during execution and playout of the computer game, the device may execute the aforementioned conversational digital assistant, which again might include or be established by an LLM such as a generative pretrained transformer model. From block 510 the logic may then proceed to block 520.

At block 520 the device may receive verbal input from the player, as may be detected by a microphone in the user’s local environment. The logic may then proceed to block 530 where the device may provide the verbal input to the conversational digital assistant (e.g., to the LLM in particular). The verbal input may be provided as an audio-based input, and/or may be provided as text converted from the player’s audible speech using a speech-to-text algorithm.

Thereafter, the logic may proceed to block 540 where the device may determine one or more non-verbal responses based on the processing of the verbal input, and then output the non-verbal response at block 550. Again note that these non-verbal responses may be based on one or a combination of rules-based algorithms (for particular responses to provide to particular inputs) and/or generative outputs received from the LLM itself.

Thus, in one specific example, at block 540 the device may execute the LLM to process the verbal input in combination with the game state data received at block 500 to then output a generative response that is inferred based on one or more current game states and the content of the user’s audible input itself. The logic may then proceed to block 550 where the device may output the determined non-verbal response(s), which again may include visual, tactile, and/or audible non-verbal responses like the examples discussed above in reference to FIGS. 3 and 4. Also note here that the LLM’s activation layer may output the inferred response as a text-based natural language command which the digital assistant may then execute external to the LLM, and/or the activation layer of the LLM may output the inferred response as a computer-coded text string command which the digital assistant may then execute external to the LLM. Either way, the assistant may ultimately output the non-verbal response itself by executing the inferred command from the activation layer of the LLM per this example.

From block 550 the logic may then proceed to block 560. At block 560 the device may, as appropriate, execute follow-up commands within the game at a later time, as might have already been registered by the device based on the verbal input received at block 520. So, for example, at block 560 the device might alert the user that a boss character is coming up behind the user’s character in the game world according to the example of FIG. 4.

FIG. 6 shows additional logic that may be executed by the device(s) of FIG. 5 to train the digital assistant/LLM of FIG. 5 before deployment (and/or for additional training after deployment). Beginning at block 600, the logic may provide, as training input, at least one dataset that includes natural language user inputs and game state data as well as respective ground truth non-verbal responses to execute based on the given user input/game state data. The logic may then proceed to block 610 where machine learning algorithms such as, but not limited to, deep learning algorithms, reinforcement learning algorithms, and/or unsupervised learning algorithms may be executed to train the assistant/LLM to generate novel generative responses in the future in response to novel/different audible inputs that might be received in the future. So, for example, natural language user inputs and respective ground truth non-verbal responses may be used to train at block 610, where the ground-truth responses pertain to non-verbal acknowledgements of the user speaking, game-specific assistance in playing the game itself, indications of the registering of user commands to be executed in the future, and/or other types of non-verbal responses.

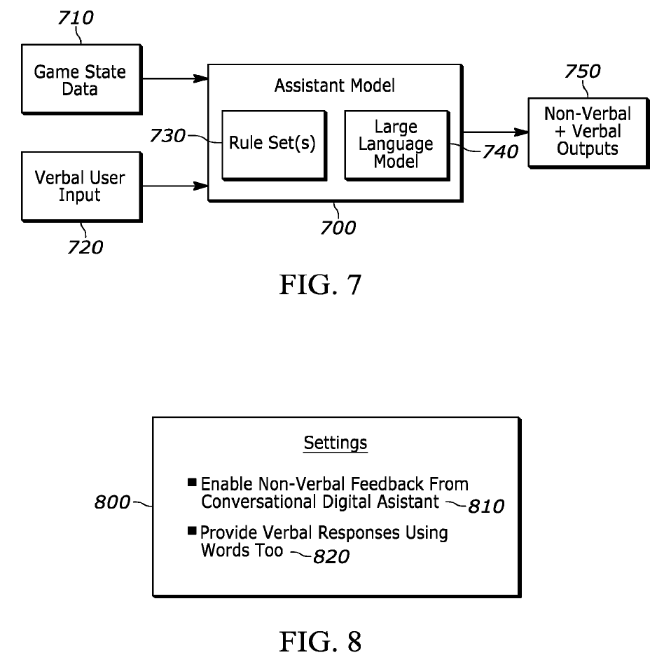

Moving on to FIG. 7, a schematic is shown of example software/artificial intelligence architecture 700 that may be used for a conversational digital assistant model consistent with present principles. As shown in FIG. 7, game state data 710 from the game engine of the particular computer game that is being executed may be provided as input to the conversational digital assistant model 700 to provide game-instance-specific context to the model 700 to help the model 700 provide an appropriate non-verbal output. Verbal user input 720 may also be provided as input, whether in the form of audio detected at a microphone and/or as text converted from the audio itself. The model may then use one or more rule sets 730 and/or an LLM 740 to determine at least one non-verbal output 750 (and possibly verbal outputs as well). Thus, in at least some examples, non-verbal output 750 may be an inference from an activation layer of the LLM 740. The inference 750 may then be provided to the game engine for presentation/execution. Additionally or alternatively, the inference 750 may be provided to a higher-level software module on the server/game console for presentation/execution outside the game environment itself.

With respect to the rule sets 730, note that a system administrator, console manufacturer, game developer, or other party may create the set(s). The sets themselves may indicate various if/then rulesets, for example. E.g., programming language may be used to write a rule where if the user asks which button performs a specific game action, the system looks up the game action in a data table of game actions and then reports the game action to the user. As another example, if the user asks how to perform a particular game maneuver with the user’s game character, the system looks up the maneuver in a data table of character maneuvers and then reports the appropriate maneuver to the user (e.g., in the form of pictures of joystick and button actions to take in a particular sequence to perform the relevant maneuver).

Now in reference to FIG. 8, an example settings graphical user interface (GUI) is shown that may be presented on a display to configure one or more settings of a client device, console, computer game, etc. to undertake present principles. The GUI 800 may be presented based on a user navigating a device or game menu, for example. The example options described below may be selected via touch, cursor, or other input directed to the associated check box per this example.

As shown in FIG. 8, the GUI 800 may include a first option 810 that may be selectable a single time to set/configure the device to, in multiple future instances, provide non-verbal outputs in response to conversational natural language verbal inputs consistent with present principles. So, for example, selection of the option 810 may configure the device to in the future take the actions described above, including those in reference to FIGS. 2-7. Using this option, the user may thus toggle the conversational digital assistant on and off as desired.

FIG. 8 also shows that the settings GUI 800 may include a second option 820 that may be selectable a single time to set/configure the device to, in multiple future instances, also provide verbal outputs in response to conversational natural language verbal inputs consistent with present principles. So, for example, while presentation of verbal outputs may not be enabled based on selection of option 810 alone, such verbal word-based outputs (whether audible or visual) may be enabled based on selection of the option 820 in particular.

Moving on from FIG. 8, other example non-verbal responses that may be provided in response to verbal natural language inputs will now be described. Suppose as a first example that a user exclaims “Which way to the basement on this game level?” and that this is provided as a verbal input to the conversational digital assistant. Assuming that the appropriate direction is down based on the current game context/character location as identified from the game state data, the assistant may then generate a non-verbal tactile response in the form of vibrating the computer game controller downward and/or at a lower area of the controller to indicate the downward direction.

Suppose as a second example that the user provides an audible input for which a binary response is inferred for output. The binary response might be a yes/no response or another type of binary response. But assuming a yes/no response for this example, the corresponding non-verbal audible response may include a first predetermined sound corresponding to “yes” and a second predetermined sound corresponding to “no”, where the sounds are different from each other. Additionally or alternatively, the non-verbal response may include actuating a first button on a computer game controller for “yes” and actuating a second button on the computer game controller for “no”. Actuating the button itself may therefore include illuminating the triangle button on the controller since it has a green color to signify “yes”, or illuminating the “O” button on the controller since it has a red color to signify “no”. Actuating the button may also include vibrating the respective button on the controller relative to other portions of the computer game controller (e.g., vibrating the triangle button for “yes” or the “O” button for “no”, or vibrating the whole controller once for “yes” and twice for “no”).

Thus, a large language model may be used to have a free-range conversation with a computer game system, where this conversation is not necessarily with another human player or virtual character within the game or even with the game engine itself. Instead, the conversation may be made with the gaming system/console. The system/console may then non-verbally have a running conversation with the user, non-verbally signaling to user that it is following the context/conversation by controlling lighting and vibrating and even controlling peripheral devices for non-verbal communication.

The non-verbal outputs may therefore acknowledge commands, give feedback about what is happening in game, and alert users to certain things. Audible non-verbal feedback may also be presented on speakers of a display, speakers on the computer game controller itself, and/or at other connected speakers.

Thus, if a user says, “Oh no, is my inventory full again?”, the system or game engine may non-verbally respond that the user’s character should go to nearest virtual merchant, auto-stash inventory items, and/or auto-destroy inventory items with lowest value. Light intensity may also be used to indicate how full the inventory is. So, for example, the border 415 may light up in a blue color of varying intensity from high to low corresponding to incremental high to low levels of inventory fullness.

Gaze tracking and gesture identification may also be used to help identify a context in which the user is speaking to determine how to respond. For example, if the user says, “What’s that?” while one or both of looking at an object on screen and pointing with a finger at the object on screen, the system may non-verbally respond with a computer graphic answering the question after identifying the object itself through gaze tracking/gesture ID.

Verbal user inputs may also be used to queue/register non-verbal game commands for future execution rather than immediate execution. For example, a user might speak in natural language that when a boss character performs a certain move within the game, the assistant is to control the user’s own virtual character to counteract the boss’s move in a way specified by the user verbally (e.g., “dodge away from the attack”). This verbal input may be processed and queue for execution while the user is not even engaged with the boss, but later when the user is in fact engaged with the boss the user need not provide any additional user input for that action and instead the assistant may autonomously execute the user-requested action. Also, to signify that the assistant is actually taking the action instead of the user themselves, the user’s controller may vibrate while the counter-move is being performed and also a graphic overlay may be presented onscreen. And note here as an additional non-limiting aspect of this example that should the assistant take a beneficial game action for the user rather than the user performing the action themselves, the game engine may not award any points, trophies, or other benefits to the user/player profile since the user did not actually perform the action themselves.

As another example, if the system determines from verbal exclamations that the user is having a difficult time playing a given video game, an appropriate controller button to press to execute an upcoming game action (e.g., the “X” button) may begin to slowly pulse with vibration to indicate that the user should take action at the appropriate time themselves by pressing the “X” button. Or the “X” button might pulse with vibration during a registered game action that is being autonomously executed by the assistant itself.

As another example, if the user instructs the game engine to change the current field of view for the player’s character by saying something like “look over there”, and the assistant is unsure of which direction the user is indicating, the assistant may progressively blink a respective screen border corresponding to each potential direction. E.g., the assistant may illuminate a left screen border with a green color, a top screen border with a blue color, and a right screen border with a red color. The user may then choose the intended direction by providing follow-up audible verbal input indicating “green”, “blue”, or “red” for the intended direction. The assistant might also progressively vibrate the user’s computer game controller in a leftward direction, forward direction, and then rightward direction to non-verbally signify that the assistant has raised an ambiguity for the user to verbally resolve with a choice of “left”, “forward”, or “right”, respectively.

Also note more generally that computer game controllers consistent with present principles may include controllers suitable for playing so-called 2D games that are presented on a single display spaced from the user as well as extended reality controllers suitable for playing 3D games rendered stereoscopically.

As yet another example, to non-verbally acknowledge a user’s verbal input but where the assistant is still processing the input or searching for an answer, the border 415 might slowly blink to indicate as much. This way, the user knows that the assistant has not dropped the input and is still doing some processing in relation to it.

In terms of alerts that are registered for the future, note that the alert itself which is to be provided based on a future game action occurring may also be presented at the time of registering so the user understands what to look out for in the future (when the same alert is presented again). Thus, this may be done as both a non-verbal response acknowledging that the assistant has registered the game action to execute in the future, and so that when the same non-verbal notification is provided in the future the user may mentally tie this back to the same non-verbal notification that was already provided as an acknowledgement.

As yet another example, the border 415 may also be illuminated brightly in a certain color at the beginning of processing a user’s verbal input, and then fade to less bright shades over time as the user stops speaking or the processing reaches its conclusion. This technique may therefore help provide non-verbal yet active, real-time feedback that the user’s natural language is being tracked and processed.

Also note that a conversational digital assistant consistent with present principles may also adjust other non-game Internet of things (IoT) devices on the same network as the gaming system itself to provide additional non-verbal responses. For example, to provide a non-verbal “no” response, the assistant may dim all smart lamps in the same room of a personal residence in which the user themselves is located. Or to respond “yes”, the assistant might blink those likes off and on twice in a row (e.g., within a threshold period of time, such as five seconds). Or if the player’s character’s game health has gone below a threshold amount, the IoT lamps in the user’s room may be reduced in luminosity to signify this game context to the user. And as the character’s health further deteriorates, the lamps may progressively dim even further.

As one additional note, it is to be understood that while an assistant may receive game state data from the game engine itself, the assistant may additionally or alternatively be run as an application programming interface (API) or other software module that can execute computer vision and sound recognition on respective video and audio game data as played out by the game engine in real time to then independently identify various game contexts external to the game engine itself.

While the particular embodiments are herein shown and described in detail, it is to be understood that the subject matter which is encompassed by the present invention is limited only by the claims.

What is claimed is:

1. A method, comprising:
executing a computer game;
accessing game state data indicating a current state of the computer game;
receiving verbal input of a user during gameplay, the verbal input comprising a user question regarding a button on a controller;
executing a model to process the verbal input and the game state data;
based on the processing of the verbal input and the game state data, determining a non-verbal response comprising a suggestion to re-map one or more buttons on the controller from a first configuration to a second configuration; and
based on the determining, outputting the non-verbal response, the outputting comprising causing display of the suggestion to re-map the one or more buttons on the controller from the first configuration to the second configuration.

2. The method of claim 1, further comprising:
re-mapping the one or more buttons on the controller from the first configuration to the second configuration.

3. The method of claim 1, wherein the non-verbal response further comprises illumination of a symbol of a peripheral device different from the controller, the symbol on the peripheral device corresponding to the button, and wherein the outputting the non-verbal response further comprises:
transmitting first instructions to the peripheral device different from the controller, the first instructions causing illumination of the symbol of the peripheral device corresponding to the button.

4. The method of claim 3, the outputting the non-verbal response further comprising
transmitting second instructions causing illumination of the button of the controller, the illumination being in a color,
wherein the first instructions causing illumination of the symbol on the peripheral device different from the controller further comprise the illumination being in the color.

5. The method of claim 1, wherein the non-verbal response comprises a sound effect sourced from the computer game.

6. The method of claim 1, wherein the non-verbal response further comprises a non-verbal tactile response, the non-verbal tactile response comprising:
vibrating, to indicate a direction based on the verbal input, the controller in the direction or at a particular location corresponding to the direction.

7. The method of claim 1, wherein the non-verbal response further comprises a first predetermined sound corresponding to “yes” or a second predetermined sound corresponding to “no”.

8. A method, comprising:
executing a computer game;
accessing game state data indicating a current state of the computer game;
receiving verbal input of a user during gameplay, the verbal input comprising a user question regarding a button of a controller;
executing a model to process the verbal input and the game state data;
based on the processing of the verbal input and the game state data, determining a non-verbal response comprising illumination of a symbol of a peripheral device different from the controller, the symbol on the peripheral device corresponding to the button; and
based on the determining, outputting the non-verbal response, the outputting comprising transmitting instructions to the peripheral device different from the controller, the instructions causing illumination of the symbol of the peripheral device corresponding to the button.

9. The method of claim 8, wherein the peripheral device comprises a plurality of three-dimensional shapes, each three-dimensional shape in the plurality of three-dimensional shapes comprising an independently controllable light, each three-dimensional shape in the plurality of three-dimensional shapes corresponding to a respective symbol on a respective button of the controller, and wherein the symbol on the peripheral device corresponding to the button is a three-dimensional shape in the plurality of three-dimensional shapes.

10. The method of claim 9, wherein each three-dimensional shape in the plurality of three-dimensional shapes illuminates in a respective color, and each respective color being different from one another.

11. The method of claim 8, wherein the instructions are first instructions, the outputting the non-verbal response further comprising:
transmitting second instructions causing illumination of the button of the controller, the illumination being in a color,
wherein the first instructions causing illumination of the symbol on the peripheral device different from the controller further comprise the illumination being in the color.

12. The method of claim 8, wherein the non-verbal response further comprises a suggestion to re-map one or more buttons on the controller from a first configuration to a second configuration, and wherein the outputting further comprises causing display of the suggestion to re-map the one or more buttons on the controller from the first configuration to the second configuration.

13. The method of claim 8, wherein the non-verbal response comprises a sound effect sourced from the computer game.

14. The method of claim 8, wherein the non-verbal response further comprises a non-verbal tactile response, the non-verbal tactile response comprising:
vibrating, to indicate a direction based on the verbal input, the controller in the direction or at a particular location corresponding to the direction.

15. The method of claim 8, wherein the non-verbal response further comprises a first predetermined sound corresponding to “yes” or a second predetermined sound corresponding to “no”.

16. A method, comprising:
executing a computer game;
accessing game state data indicating a current state of the computer game;
receiving verbal input of a user during gameplay, the verbal input comprising a request to alert the user in response to a game action occurring;
executing a model to process the verbal input and the game state data;
based on the processing of the verbal input and the game state data, determining a non-verbal response comprising an acknowledgement of the request, the non-verbal response being a response other than execution of a command within the computer game; and
based on the determining, outputting the non-verbal response without pausing the computer game.

17. The method of claim 16, further comprising:
subsequent to outputting the non-verbal response as a first output, identifying the game action as occurring; and
based on identification of the game action as occurring, rendering a second output different from the first output, the second output establishing an alert in conformance with the request.

18. The method of claim 16, wherein the non-verbal response further comprises a non-verbal visual response, the non-verbal visual response comprising:
presenting a screen border in a particular color, illuminating a button on a controller, or illuminating a light on a peripheral device different from the controller.

19. The method of claim 16, wherein the non-verbal response further comprises a sound effect sourced from the computer game.

20. The method of claim 16, wherein the non-verbal response further comprises vibrating a controller.
